(19) United States
(12) Patent Application Publication
(10) Pub. No.: US 2004/0093695 A1
(43) Pub. Date: May 20, 2004

(54) Knob

(76) Inventor: Glen Heavenor, Glasgow (GB)

Correspondence Address: FLESHNER & KIM, LLP, P.O. BOX 221200, CHANTILLY, VA, 20153, US

(21) Appl. No.: 10/468,097

(22) PCT Filed: Feb. 5, 2002
(86) PCT No.: PCT/GB02/00487

(30) Foreign Application Priority Data
Feb. 16, 2001 (GB) 0103860.3

(51) Int. Cl. A47J 45/06

(52) U.S. Cl. 16/430

(57) ABSTRACT

An improved knob to aid in the gripping and movement of an article is described. The knob comprises a carefully constructed head that allows the user to comfortably place forward portions of their thumb, index and middle fingers into respective recesses. Slight pressure from the user's fingers and thumb serves to clasp the knob and thereafter the knob can be easily lifted, and if required tilted and rotated by simply twisting the wrist. The knob is ideal to be employed as a handle for a cooking pot lid, as a door handle, as a handle located on the back of a chair or a handle on a tap.

The present invention relates to knobs and handles as fixed to articles, and in particular to an improved knob to aid the gripping and movement of the article by hand.

The simplest knobs consist of a spherical head mounted on a cylindrical shaft. These operate by the user positioning the palm of the hand on the top of the head opposite of the shaft. They then grip the head and by lifting the knob with the hand the attached article is raised. Further knobs have either taken on aesthetic qualities or flatten the head to a disc that provides a lip under the head perpendicular to the shaft. The lip is used as an additional grip to stop the knob from sliding out from the fingers of the hand when lifted.

Each of the prior art knobs are designed to work best when the head fits in the palm of the hand and the fingers curve both comfortably and substantially around the head to provide a firm grip of the knob. Unfortunately, as all users' hands and fingers vary in size, no single knob is ideal for all users. For knobs with a lip, the user can curve their fingers under the lip to lift the knob, but once lifted they cannot rotate the wrist easily end turn the article upside down.

It is an object of the present invention to provide an improved knob to aid in the gripping and movement of the article that obviates or mitigates one or more disadvantages of the prior art.

According to a first aspect of the present invention, there is provided a knob for affixing to a surface of an article to aid the grip on and movement of the article, the knob comprising:

a head having a substantially triangular cross-section on a first plane parallel to the surface of the article, and a recess on each side of the triangle perpendicular to the first plane; and

a means for attaching the knob to the surface of the article.

In use the recess allows the user to comfortably place forward portions of their thumb, index and middle fingers into the respective recesses. Slight pressure from the user's fingers and thumb serves to clasp the knob and the knob can then be easily lifted and if required tilted and rotated by simply twisting the wrist. An advantage of this knob is that heavier articles may be lifted due to the fact that the user can keep their upper arm close to their body during the lift operation. Additionally while supported from the user's body the article may be turned over by twisting the wrist. This is in contrast to prior art knobs having flattened heads, where the user is required to take the upper arm away from the body to grip the knob in a pincer movement and by doing so loses the support for leverage from their body.

Preferably the triangle is an equilateral triangle, such that each vertex and the bisectors are spaced 120 degrees apart. Such a knob has three-fold symmetry.

Preferably each vertex of the triangle is rounded in all planes. Thus, the knob provides a head having three knubbles located at the vertices of the triangle.

Preferably the recesses have arcuate surfaces to provide a comfortable match to the user's fingers and thumb.

The head may be mounted on a shaft. The shaft may be circular in cross-section and a base of the shaft may be held against the surface of the article by the attachment means.

The attachment means may be a screw and matching tapered bore. Preferably the tapered bore is in a base of the knob or in the base of the shaft and the screw is located on and projecting from the surface of the article.

In a preferred embodiment, each of the knubbles is an ellipsoid. Each ellipsoid preferably has first and second axis of a first length and the third axis has a second length smaller than the first length. More preferably the first axis is located on the first plane between the intersection of the bisectors of the triangle (the centroid) and a vertex of the triangle. Preferably also the third axis is arranged at an angle, α, to the first plane.

Preferably the angle, α, is between zero and ninety degrees. More preferably the angle, α, is 45 degrees.

Each ellipsoid may interleave with the other two ellipsoids in precession around the intersection of the bisectors. This arrangement provides three overhanging lips into which the fingers and thumb can locate under while providing a base rest for the thumb, middle finger and index finger also.

Further, the arrangement of ellipsoids may provide the inner structure for a morphology of the knob which has as its outer structure a smooth surface overlaying the inner structure. The morphology provides three undulations precessing around the intersection point which itself may be a dip in the centre of the knob.

According to a second aspect of the present invention, there is provided a cooking pot; the cooking pot including a receptacle and a lid, wherein the lid is provided with a knob according to the first aspect.

Preferably the cooking pot is a saucepan. Alternatively, the cooking pot may be a casserole dish.

Preferably in use the knob includes three apexes, such that when the knob is rested upside down to support the lid, the apexes provide a stable support structure holding the lid level.

According to a third aspect of the present invention, there is provided a door handle wherein the door handle comprising a knob according to the first aspect.

According to a fourth aspect of the present invention, there is provided a handle for a chair wherein the handle comprises a knob according to the first aspect.

According to a fifth aspect of the present invention, there is provided a tap wherein the tap comprises a knob according to the first aspect.

An embodiment of the present invention will now be described, by way of example only, with reference to the accompanying Figures, of which:

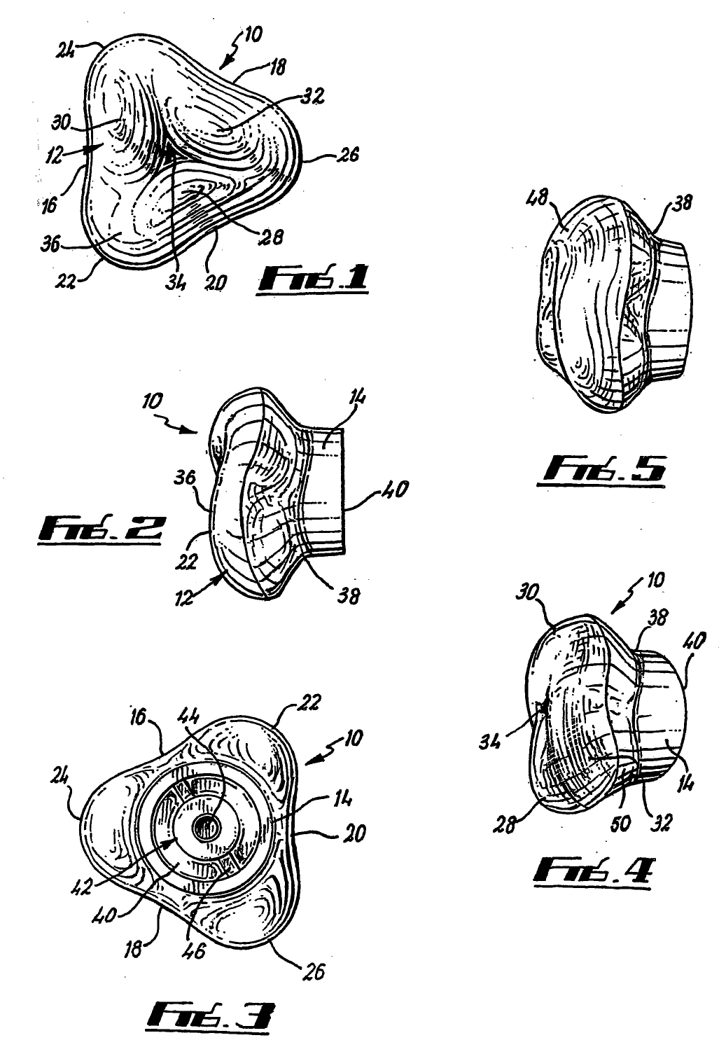

FIG. 1 is a top view of a knob in accordance with the present invention;

FIG. 2 is a side view of the knob of FIG. 1;

FIG. 3 is a bottom view of the knob of FIG. 1;

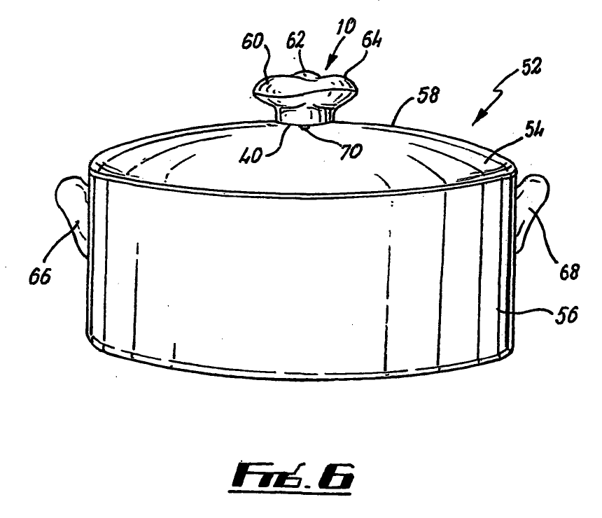

FIG. 4 is an isometric view of the knob of FIG. 1;

FIG. 5 is an alternative side view of the knob of FIG. 1; and

FIG. 6 is a side view of a cooking pot in accordance with a second aspect of the present invention.

With reference to the Figures, like numerals refer to like parts throughout the several views of the drawings.

Reference is first made to FIG. 1 of the drawings, which shows a knob generally indicated by reference numeral 10 in accordance with a first embodiment of the present invention. The knob 10 comprises a head 12 mounted on a shaft 14 The head 12 is generally of a triangular cross-section. The triangular form of the head 12 provides three sides, each side having a recess 16, 18, 20. Each recess 16, 18, 20 appears as a groove or dent on the side of the head 12. The head 12 has three vertices 22, 24, 26. The vertices are rounded and thereby the knob 10 appears to have three knubbles 28, 30, 32 and consequently a dip in the centre 34. The knubbles 28, 30, 32 provide an upper surface 36 of the knob 10 with an undulating surface having three peaks near the vertices 22, 24, 26 and three dips there between with a further dip at the centre 34.

Reference is now made to FIG. 2 of the drawings, which depicts the knob 10 from a side view. The undulations on the top surface 36 are now clearly visible. Now visible is the shaft 14 located under the head 12 and having a lower surface 40 on a base for attachment to an article such as a saucepan lid. The vertical cross-section through the knob 10 from the view of FIG. 2 would show a substantially elliptical head 12, while a horizontal cross-sectional view would show a generally triangular head 12 with a circular shaft 14. As the head 12 has a greater diameter than the shaft 14, a lip 38 is created under the head 12 by the decreasing radius.

Reference is now made to FIG. 3 of the drawings, which illustrates the knob 10 from a bottom or underside view, providing an illustration of the attachment means 42. The attachment means 42 is located on the lower surface 40 and comprises a support 46 and a recessed tapered hole 44 against which may sit a surface of an article. The article would in turn have an aperture dimensioned to fit over the recess 44 and allow a screw to engage with the screw thread of the tapered hole 44 and hold an article against the surface 40.

The morphology of the knob 10 is more clearly shown in FIG. 4. The morphology of an article comprises its inner structure and its outer surface. The inner structure of the knob 10 is in the form of three ellipsoids tilted by the same angle, for instance 45 degrees from the plane of the lower surface 40, and appearing to precess around the central point 34. Each ellipsoid provides an upper ridge 48 and a lower ridge 50. The area between the upper ridge of one ellipsoid and a lower ridge of a neighbouring ellipsoid provides for a recess 16, 18, 20. The outer surface providing the morphology of the knob 10 is a smooth contoured plane having three undulations between the knubbles 28, 30, 32 around a central dip 34. The surface is rounded over the knubbles. 28, 30, 32 into the lip 38 and down the shaft 14. This morphology is better seen in FIG. 5 and illustrates that as the ellipsoids are tilted three apexes 60, 62, 64 are created on the upper surface 36 each being equally offset from the vertices 22, 24, 26.

Reference is now made to FIG. 6 of the drawings, which depicts a cooking pot generally referred to by reference numeral 52. The cooking pot 52 comprises a receptacle 56 having a lid 54 mounted thereon. The lid 54 has an upper surface 58 and upon this upper surface 58 is attached a knob 10. The knob 10 is as described hereinbefore with reference to FIGS. 1 to 5. Lower surface 40 of the knob 10 abuts the surface 58 of the lid 54. The cooking pot 52 also comprises additional handles 66 and 68 which aid in the lifting of the entire cooking pot 52.

The use of the knob 10 will now be described with reference to the full set of drawings. In use the knob 10 is attached by attachment means 42 to the surface of an article, for instance the surface 58 of the lid 54 of the cooking pot 52. In the embodiment shown attachment is achieved by a screw 70, located through the surface 58 of the lid 54, engaging with the tapered bore 44 on the lower surface 40 of the knob 10. To raise the article, lid 54, the user positions their hand above the knob 10 in such a fashion that the thumb, first and middle fingers locate in recesses 16, 18, 20. The fingers and thumb slide comfortably between the ellipsoids, as described hereinbefore, using the upper ridge 48 for leverage and the lower ridge 50 for support. A slight tension applied by the fingers and thumb allows the article to be raised by simply lifting the knob 10 upwards. If required, the article can be positioned upside down by rotating the wrist until the knob 10 is in a rotated position. Further apexes 60, 62, 64 of the knob may be rested against a further surface in order to support the lid 54. As there are three apexes 60, 62, 64, of equal heights the lid 54 is stably supported.

The position of the fingers and thumb in recesses 16, 18, 20 provide such support in the lifting operation, that the user's upper arm may remain close to the user's body so that they can use the elbow as a lever and thereby lift heavy lids. Such heavier lids may be those found on cast iron saucepans and the like.

A further advantage of the present invention is in the removal of the need for the users palm to engage with a surface of the knob. Thus as long as the dimensions of the knob do not exceed a comfortable separation of the distance between the thumb middle and first finger, for instance a head diameter of approximately 6 cm, the knob may be used in an identical manner by users with a variety of hand and finger sizes.

Various modifications may be made to the embodiment of the invention herein described without departing from the scope thereof. Such modifications may take the form of replacing the cooking pot with a saucepan, casserole dish or the like.

The present invention may also be readily employed as a handle for a door or chair, as a tap or generally in the field of architectural iron mongering where its improved features for gripping and moving of the related article may be exploited.

Alternative attachment means may be used, for instance a plurality of tapered recesses or a projecting screw thread from the knob to engage with complimentary fixings on the article.

1. A knob for affixing to a surface of an article to aid the grip on and movement of the article, the knob comprising:
a head having a substantially triangular cross-section on a first plane parallel to the surface of the article,
a recess on each side of the triangle perpendicular to the first plane; and
a means for attaching the knob to the surface of the article.

2. A knob as claimed in claim 1, wherein the triangular cross-section is an equilateral triangle.

3. A knob as claimed in claim 1 or claim 2 wherein each vertex of the triangle is rounded in all planes.

4. A knob as claimed in any of the preceding Claims wherein the recesses have arcuate surfaces to provide a comfortable match to the user's fingers and thumb.

5. A knob as claimed in any of the preceding Claims wherein the head is mounted on a shaft.

6. A knob as claimed in claim 5 wherein the shaft comprises a circular cross-section.

7. A knob as claimed in claim 5 or claim 6 wherein the shaft is held against the surface of the article by the attachment means.

8. A knob as claimed in any of the preceding Claims wherein the attachment means comprises a screw and matching tapered bore.

9. A knob as claimed in claim 8 wherein the tapered bore is located in the base of the knob and the screw is located on and projected from the surface of the article.

10. A knob as claimed in claim 8 wherein the tapered bore is located in the base of the shaft and the screw is located on and projected from the surface of the article.

11. A knob as claimed in any of the preceding Claims wherein the rounded vertex comprises an ellipsoid.

12. A knob as claimed in claim 11 wherein the ellipsoid comprises a first and second axis of a first length and a third axis of a second length smaller than the first length.

13. A knob as claimed in claim 12 wherein the first axis is located on the first plane between the centroid and a vertex of the triangular cross section.

14. A knob as claimed in claim 12 or claim 13 wherein the third axis is arranged at an angle α to the first plane.

15. A knob as claimed in claim 14 wherein the angle α is between zero and ninety degrees.

16. A knob as claimed in claims 11 to 15 wherein each ellipsoid interleaves with the other two ellipsoids in precession around the centroid.

17. A knob as claimed in claims 11 to 16 wherein the arrangement of ellipsoids provides the inner structure for a morphology of the knob which has as its outer structure a smooth surface overlaying the inner structure.

18. A cooking pot comprising a receptacle and a lid, wherein the lid is provided with a knob as claimed in any of the preceding Claims.

19. A cooking pot as claimed in claim 16 wherein the pot comprises a saucepan.

20. A cooking pot as claimed in claim 16 wherein the pot comprises a casserole dish.

21. A cooking pot as claimed in claims 16 to 18 wherein the knob comprises three apexes, such that when the knob is rested upside down to support the lid, the apexes provide a stable support structure for holding the lid level.

22. A door handle comprising a knob as claimed in claims 1 to 17.

23. A handle for a chair wherein the handle comprises a knob as claimed in claims 1 to 17.

24. A tap wherein the tap comprises a knob as claimed in claims 1 to 17.
